(19) United States
(12) Patent Application Publication
(10) Pub. No.: US 2003/0171912 A1
(43) Pub. Date: Sep. 11, 2003

(54) Translation apparatus

(76) Inventors: Arnoldo Cabello, Machesney Park, IL (US); Ruth J. Cabello, Machesney Park, IL (US)

Correspondence Address: DAVID J. ARCHER, 9790 FOREST PRESERVE RD., DURAND, IL, 61024, US

(21) Appl. No.: 10/074,184

(22) Filed: Feb. 12, 2002

(51) Int. Cl. G06F 17/28

(52) U.S. Cl. 704/3

(57) ABSTRACT

A translation apparatus is disclosed for translating words and phrases from a first language into a second language and from the second language into the first language. The apparatus includes a microphone, a receiver and an electronic device which is electrically connected to the receiver for analyzing a series of electronic signals and for generating a first and a second series of impulses. A visual display is electrically connected to the electronic device for receiving the first and second series of impulses from the electronic device and a switching system is provided for selectively switching the visual display between a first and a second mode of operation thereof.

### BACKGROUND OF THE INVENTION

1. Field of the Invention

The present invention relates to a translation apparatus for translating words and phrases from a first language into a second language. More specifically, the apparatus according to the present invention also translates from the second language into the first language.

2. Background information

Many travelers have experienced problems in communicating with foreigners. Also, in the United States of America, it is estimated that there are approximately 15 million residents who do not speak English.

Systems such as Via Voice enable spoken words to be transposed into written information in the same language. Also, CD programs are available for translating written documents and information into foreign text by means of a computerized translation between languages. However, both of these separate systems have to be installed in powerfull computers in order to be used. Via Voice is a registered TRADEMARK of IBM. Moreover, Applicants are unaware of any system that combines the transposing and translating feature of the aforementioned systems. Furthermore, the present invention provides a light weight hand held device for achieving the transposing and translation functions.

The present invention relates to a simple hand held device which readily permits a user to orally enter a few words or phrases and then have such words translated into a selected language so that such translation can then be displayed for the foreign speaking person to read. The foreign speaking person can then reply so that the reply is translated and displayed in English.

The arrangement according to the present invention envisages the provision of electronic translation cards that can be selected for a number of languages such as Spanish, Puerto Rican, Italian and Sicilian.

Therefore, it is a primary feature of the present invention to provide a translation apparatus that overcomes the problems associated with the prior art arrangements.

Another feature of the present invention is the provision of a translation apparatus that is extremely compact in construction.

A further feature of the present invention is the provision of a translation apparatus that is of relatively low cost.

Another feature of the present invention is the provision of a translation apparatus that permits communication between different language groups.

Other features and advantages of the present invention will be readily apparent to those skilled in the art by a consideration of the detailed description of a preferred embodiment of the present invention contained herein.

### SUMMARY OF THE INVENTION

The present invention relates to a translation apparatus for translating words and phrases from a first language into a second language and from the second language into the first language. The apparatus includes a microphone for transposing spoken words and phrases into a series of electronic signals. A receiver is electrically connected to the microphone for receiving the series of electronic signals from the microphone. An electronic device is electrically connected to the receiver for analyzing the series of electronic signals and for generating a first and a second series of impulses. A visual display is electrically connected to the electronic device for receiving the first and second series of impulses from the electronic device. A switching system is provided for selectively switching the visual display between a first and a second mode of operation thereof. The arrangement is such that when the words and phrases are spoken into the microphone in the first language, the series of electronic signals corresponding to the words and phrases in the first language are analyzed by the electronic device which generates the first series of impulses which are displayed on the visual display in the first language when the switching system is switched to the first mode of operation thereof. The second series of impulses are displayed on the visual display in the second language when the switching system is switched to the second mode of operation thereof. Also, the switching system further switches the visual display between a third and a fourth mode of operation thereof. The arrangement is such that when the words and phrases are spoken into the microphone in the second language, a further series of electronic signals corresponding to the words and phrases in the second language are analyzed by the electronic device which generates a third series of impulses which are displayed on the visual display in the second language when the switching system is switched to the third mode of operation thereof. Furthermore, a fourth series of impulses is generated by the electronic device for display on the visual display in the first language when the switching system is switched to the fourth mode of operation thereof.

In a more specific embodiment of the present invention, the translation apparatus further includes a housing for housing the microphone, receiver, electronic device , visual display and the switching system.

Also, the translation apparatus further includes a speaker electrically connected to the electronic device for generating an oral reproduction of the words and phrases in the first and second languages.

A volume control is electrically connected to the speaker for controlling a volume level of the oral reproduction.

Additionally, an electrical socket is provided which is electrically connected to the speaker and a plug cooperates with the electrical socket. A headset is electrically connected to the plug for enabling a user to listen to the oral reproduction when the plug is inserted into the electrical socket.

The translation apparatus also includes a source of electrical power which is selectively connected to the microphone, receiver, electronic device , visual display and the switching system. Also, an on/off switch is disposed between the source of electrical power and the microphone, receiver, electronic device, visual display and the switching system for selectively powering the translation apparatus.

The electronic device includes a card slot and a translation card for insertion thereof into the card slot.

More specifically, a translation card for a particular language is provided so that a card for a particular language can be selected from several translation cards. A selected card is inserted into the card slot as required.

Scroll buttons are provided for scrolling through the translation cards and for automatically inserting a selected card into the card slot.

The visual display also includes a contrast control for controlling a contrast between the words and phrases displayed on the visual display and a background.

The switching system includes a first button for use when entering the words and phrases in the first language. A second button is provided for use when entering the words and phrases in the second language.

Additionally, a third button is provided for making a selection of which language is to be translated and a fourth button enables recording of the words and phrases.

Many modifications and variations of the present invention will be readily apparent to those skilled in the art by a consideration of the detailed description contained hereinafter taken in conjunction with the annexed drawings which show a preferred embodiment of the present invention. However, such modifications and variations fall within the spirit and scope of the present invention as defined by the appended claims.

Included in such modifications would be the provision with the visual display of a touch sensitive screen that would enable the user to make selections by touching the appropriate portion of the screen rather than having to depress selected control buttons.

### BRIEF DESCRIPTION OF THE DRAWINGS

FIG. 1 is a front elevational view partially in section of a translation apparatus according to the present invention;

FIG. 2 is a view taken on the line 2-2 of FIG. 1;

FIG. 3 is a view taken on the line 3-3 of FIG. 2; and

FIG. 4 is a view taken on the line 4-4 of FIG. 1.

Similar reference characters refer to similar parts throughout the various views of the drawings.

### DETAILED DESCRIPTION OF THE DRAWINGS

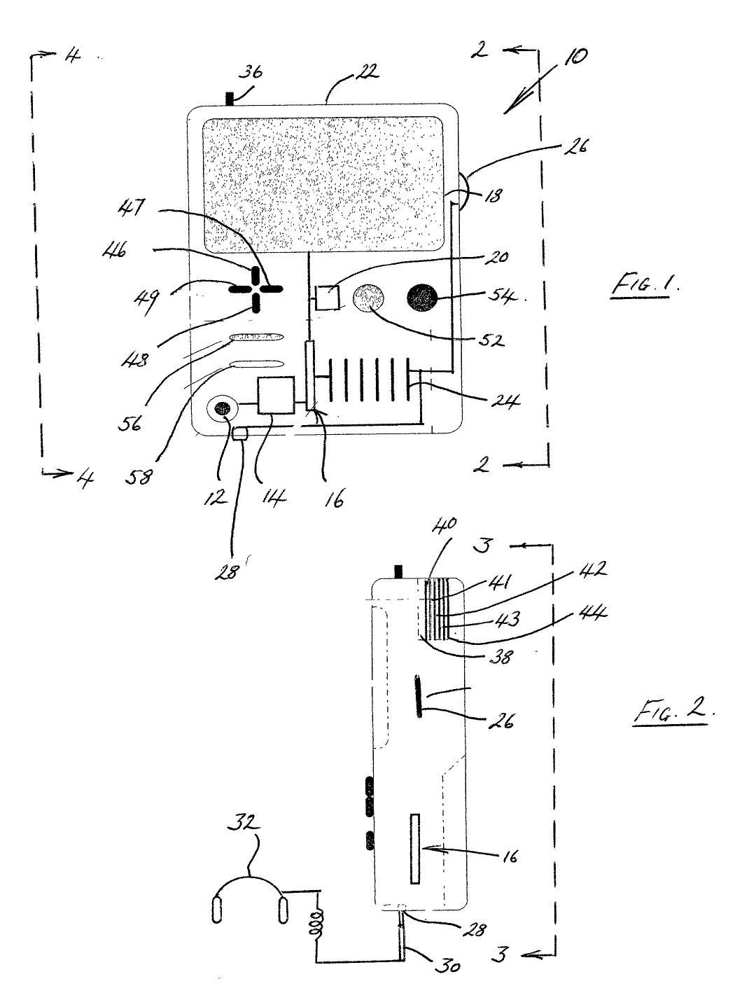

The present invention relates to a translation apparatus generally designated 10 for translating words and phrases from a first language into a second language and from the second language into the first language. FIG. 1 is a front elevational view partially in section of the apparatus 10 which includes a microphone 12 for transposing spoken words and phrases into a series of electronic signals. A receiver 14 is electrically connected to the microphone 12 for receiving the series of electronic signals from the microphone 12. An electronic device generally designated 16 is electrically connected to the receiver 14 for analyzing the series of electronic signals and for generating a first and a second series of impulses. A visual display or VDU 18 is electrically connected to the electronic device 16 for receiving the first and second series of impulses from the electronic device. 16. A switching system 20 is provided for selectively switching the visual display 18 between a first and a second mode of operation thereof. The arrangement is such that when the words and phrases are spoken into the microphone 12 in the first language, the series of electronic signals corresponding to the words and phrases in the first language are analyzed by the electronic device 16 which generates the first series of impulses which are displayed on the visual display 18 in the first language when the switching system 20 is switched to the first mode of operation thereof. The second series of impulses are displayed on the visual display 18 in the second language when the switching system 20 is switched to the second mode of operation thereof. Also, the switching system 20 further switches the visual display 18 between a third and a fourth mode of operation thereof. The arrangement is such that when the words and phrases are spoken into the microphone 12 in the second language, a further series of electronic signals corresponding to the words and phrases in the second language are analyzed by the electronic device 16 which generates a third series of impulses which are displayed on the visual display 18 in the second language when the switching system 20 is switched to the third mode of operation thereof. Furthermore, a fourth series of impulses is generated by the electronic device 16 for display on the visual display 18 in the first language when the switching system 20 is switched to the fourth mode of operation thereof.

As shown in FIG. 1, the translation apparatus 10 further includes a housing 22 for housing the microphone 12, receiver 14, electronic device 16, visual display 18 and the switching system 20.

Also, the translation apparatus 10 further includes a speaker 24 electrically connected to the electronic device 16 for generating an oral reproduction of the words and phrases in the first and second languages.

FIG. 2 is a view taken on the line 2-2 of FIG. 1. As shown in FIG. 2, a volume control 26 is electrically connected to the speaker 24 for controlling a volume level of the oral reproduction.

Additionally, an electrical socket 28 is provided which is electrically connected to the speaker 24 and a plug 30 cooperates with the electrical socket 28. A headset 32 is electrically connected to the plug 30 for enabling a user to listen to the oral reproduction when the plug 30 is inserted into the electrical socket 28.

FIG. 3 is a view taken on the line 3-3 of FIG. 2. As shown in FIG. 3, the translation apparatus 10 also includes a source of electrical power 34 which is selectively connected to the microphone 12, receiver 14, electronic device 16, visual display 18 and the switching system 20. Also, an on/off switch 36 is electrically disposed between the source of electrical power 34 and the microphone 12, receiver 14, electronic device 16, visual display 18 and the switching system 20 for selectively powering the translation apparatus 10. Preferably, the source of electrical power includes four AAA batteries 35.

As shown in FIG. 2, the electronic device 16 includes a card slot 38 and a translation card 40 for insertion thereof into the card slot 38.

More specifically, a translation card 40 for a particular language is provided so that a card for a particular language can be selected from several translation cards 40, 41, 42, 43 and 44. A selected card such as card 40 is inserted into the card slot 38 as required.

As shown in FIG. 1, scroll buttons 46, 47, 48 and 49 are provided for scrolling through the translation cards 40-44 and for automatically inserting a selected card into the card slot 38.

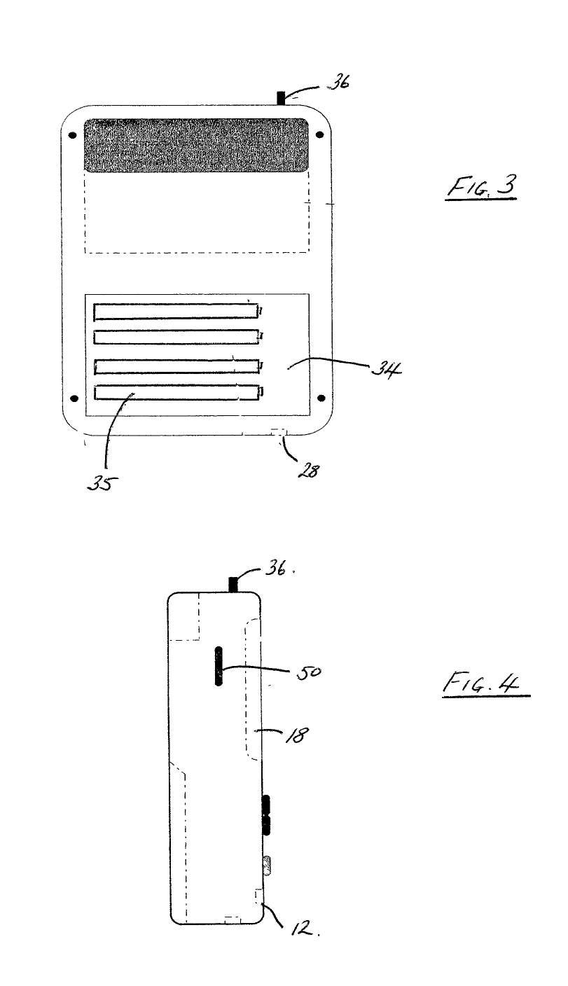

FIG. 4 is a view taken on the line 4-4 of FIG. 1. As shown in FIG. 4, the visual display 18 also includes a contrast control 50 for controlling a contrast between the words and phrases displayed on the visual display 18 and a background.

As shown in FIG. 1, the switching system 20 includes a first button 52 for use when entering the words and phrases in the first language. A second button 54 is provided for use when entering the words and phrases in the second language.

Additionally, a third button 56 is provided for making a selection of which language is to be translated and a fourth button 58 enables recording of the words and phrases.

In use of the apparatus according to the present invention, the user will press the English button 52 on the hand held unit and the display 18 will display the words and phrases to be translated. The words and phrases will then be translated into the required language for the foreign speaking person to read. The foreign speaking person can then press button 54 and enter words in the foreign language so that the unit translates such words into English. Thus, the apparatus according to the present invention enables the user to carry on a conversation with the foreigner. Also, the apparatus enables the user gradually to learn various foreign languages by the insertion into the card slot of a teaching translation card.

The present invention provides a unique apparatus which permits persons of different language groups to easily communicate with each other without the need of an interpreter.

What is claimed is:

1. A translation apparatus for translating words and phrases from a first language into a second language and from the second language into the first language, said apparatus comprising:
a microphone for transposing spoken words and phrases into a series of electronic signals;
a receiver electrically connected to said microphone for receiving said series of electronic signals from said microphone;
an electronic device electrically connected to said receiver for analyzing said series of electronic signals and for generating a first and a second series of impulses;
a visual display electrically connected to said electronic device for receiving said first and second series of impulses from said electronic device;
a switching system for selectively switching said visual display between a first and a second mode of operation thereof, the arrangement being such that when the words and phrases are spoken into said microphone in the first language, said series of electronic signals corresponding to the words and phrases in the first language are analyzed by said electronic device which generates said first series of impulses which are displayed on said visual display in the first language when said switching system is switched to said first mode of operation thereof, said second series of impulses being displayed on said visual display in the second language when said switching system is switched to said second mode of operation thereof; and
said switching system further switching said visual display between a third and a fourth mode of operation thereof, the arrangement being such that when the words and phrases are spoken into said microphone in the second language, a further series of electronic signals corresponding to the words and phrases in the second language are analyzed by said electronic device which generates a third series of impulses which are displayed on said visual display in the second language when said switching system is switched to said third mode of operation thereof, a fourth series of impulses generated by said electronic device being displayed on said visual display in the first language when said switching system is switched to said fourth mode of operation thereof.

2. A translation apparatus as set forth in claim 1 further including:
a housing for housing said microphone, receiver, electronic device , visual display and said switching system.

3. A translation apparatus as set forth in claim 1 further including:
a speaker electrically connected to said electronic device for generating an oral reproduction of the words and phrases in said first and second languages.

4. A translation apparatus as set forth in claim 3 further including:
a volume control electrically connected to said speaker for controlling a volume level of said oral reproduction.

5. A translation apparatus as set forth in claim 3 further including:
an electrical socket electrically connected to said speaker;
a plug cooperating with said electrical socket;
a headset electrically connected to said plug for enabling a user to listen to said oral reproduction when said plug is inserted into said electrical socket.

6. A translation apparatus as set forth in claim 1 further including:
a source of electrical power selectively connected to said microphone, receiver, electronic device, visual display and said switching system;
an on/off switch disposed between said source of electrical power and said microphone, receiver, electronic device , visual display and said switching system for selectively powering said translation apparatus.

7. A translation apparatus as set forth in claim 1 wherein said electronic device includes:
a card slot;
a translation card for insertion thereof into said card slot.

8. A translation apparatus as set forth in claim 7 wherein
said translation card for a particular language is provided so that a card for a particular language can be selected from several translation cards, a selected card being inserted into said card slot as required.

9. A translation apparatus as set forth in claim 8 further including:
scroll buttons for scrolling through said translation cards and for automatically inserting a selected card into said card slot.

10. A translation apparatus as set forth in claim 1 wherein
said visual display further includes:
a contrast control for controlling contrast between the words and phrases displayed on said visual display and a background.

11. A translation apparatus as set forth in claim 1 wherein said switching system includes:
a first button for use when entering the words and phrases in the first language;
a second button for use when entering the words and phrases in the second language.

12. A translation apparatus as set forth in claim 1 1 wherein said switching system further includes:
a third button for making a selection of which language is to be translated;
a fourth button for recording the words and phrases.

13. A translation apparatus for translating words and phrases from a first language into a second language and from the second language into the first language, said apparatus comprising:
a microphone for transposing spoken words and phrases into a series of electronic signals;
a receiver electrically connected to said microphone for receiving said series of electronic signals from said microphone;
an electronic device electrically connected to said receiver for analyzing said series of electronic signals and for generating a first and a second series of impulses;
a visual display electrically connected to said electronic device for receiving said first and second series of impulses from said electronic device;
a switching system for selectively switching said visual display between a first and a second mode of operation thereof, the arrangement being such that when the words and phrases are spoken into said microphone in the first language, said series of electronic signals corresponding to the words and phrases in the first language are analyzed by said electronic device which generates said first series of impulses which are displayed on said visual display in the first language when said switching system is switched to said first mode of operation thereof, said second series of impulses being displayed on said visual display in the second language when said switching system is switched to said second mode of operation thereof;
said switching system further switching said visual display between a third and a fourth mode of operation thereof, the arrangement being such that when the words and phrases are spoken into said microphone in the second language, a firther series of electronic signals corresponding to the words and phrases in the second language are analyzed by said electronic device which generates a third series of impulses which are displayed on said visual display in the second language when said switching system is switched to said third mode of operation thereof, a fourth series of impulses generated by said electronic device being displayed on said visual display in the first language when said switching system is switched to said fourth mode of operation thereof;
said electronic device further including:
a card slot; and
a translation card for insertion thereof into said card slot.

14. A translation apparatus for translating words and phrases from a first language into a second language and from the second language into the first language, said apparatus comprising:
a microphone for transposing spoken words and phrases into a series of electronic signals;
a receiver electrically connected to said microphone for receiving said series of electronic signals from said microphone;
an electronic device electrically connected to said receiver for analyzing said series of electronic signals and for generating a first and a second series of impulses;
a visual display electrically connected to said electronic device for receiving said first and second series of impulses from said electronic device;
a switching system for selectively switching said visual display between a first and a second mode of operation thereof, the arrangement being such that when the words and phrases are spoken into said microphone in the first language, said series of electronic signals corresponding to the words and phrases in the first language are analyzed by said electronic device which generates said first series of impulses which are displayed on said visual display in the first language when said switching system is switched to said first mode of operation thereof, said second series of impulses being displayed on said visual display in the second language when said switching system is switched to said second mode of operation thereof;
said switching system further switching said visual display between a third and a fourth mode of operation thereof the arrangement being such that when the words and phrases are spoken into said microphone in the second language, a further series of electronic signals corresponding to the words and phrases in the second language are analyzed by said electronic device which generates a third series of impulses which are displayed on said visual display in the second language when said switching system is switched to said third mode of operation thereof, a fourth series of impulses generated by said electronic device being displayed on said visual display in the first language when said switching system is switched to said fourth mode of operation thereof;
said translation apparatus further including:
a housing for housing said microphone, receiver, electronic device, visual display and said switching system;
a speaker electrically connected to said electronic device for generating an oral reproduction of the words and phrases in said first and second languages;
a volume control electrically connected to said speaker for controlling a volume level of said oral reproduction;
an electrical socket electrically connected to said speaker;
a plug cooperating with said electrical socket;
a headset electrically connected to said plug for enabling a user to listen to said oral reproduction when said plug is inserted into said electrical socket;
a source of electrical power selectively connected to said microphone, receiver, electronic device , visual display and said switching system;
an on/off switch disposed between said source of electrical power and said microphone, receiver, electronic device, visual display and said switching system for selectively powering said translation apparatus;
said electronic device including:
a card slot;
a translation card for insertion thereof into said card slot;
said translation card for a particular language being provided so that a card for a particular language can be selected from several translation cards, a selected card being inserted into said card slot as required;
scroll buttons for scrolling through said translation cards and for automatically inserting a selected card into said card slot;
said visual display further including:
a contrast control for controlling contrast between the words and phrases displayed on said visual display and a background;
said switching system including:
a first button for use when entering the words and phrases in the first language;
a second button for use when entering the words and phrases in the second language;
a third button making a selection of which language is to be translated; and a fourth button for recording the words and phrases.
